(19) United States
(12) Patent Application Publication
(10) Pub. No.: US 2025/0280083 A1
(43) Pub. Date: Sep. 4, 2025

(54) IMAGE PROCESSING APPARATUS CAPABLE OF SUPPRESSING DISAPPEARANCE OF CORRECTION TRACE WHEN GENERATING ELECTRONIC DOCUMENT FROM DOCUMENT, CONTROL METHOD FOR IMAGE PROCESSING APPARATUS, AND STORAGE MEDIUM

(71) Applicant: CANON KABUSHIKI KAISHA, Tokyo (JP)

(72) Inventor: SOICHIRO YOSHIGI, Tokyo (JP)

(21) Appl. No.: 19/064,021

(22) Filed: Feb. 26, 2025

(30) Foreign Application Priority Data
Mar. 1, 2024 (JP) 2024-031261

(51) Int. Cl. H04N 1/00; H04N 1/60

(52) U.S. Cl. CPC H04N 1/00822; H04N 1/00384; H04N 1/00811; H04N 1/60

(57) ABSTRACT

A mechanism capable of suppressing the disappearance of a correction trace is provided. An MFP includes a scanner unit that reads a document and obtains read image data, a data processing unit that converts the color of pixels having a brightness equal to or greater than a threshold value into white, and an operation unit capable of performing at least user operations regarding the scanner unit and the data processing unit. When a CPU of the MFP determines that a first predetermined operation has been performed, the CPU sets a reading mode of the scanner unit to a second reading mode in which the document is read under a darker condition than a first reading mode, sets the threshold value to a second threshold value that is greater than a first threshold value, and disables a change of the second reading mode and a change of the second threshold value.

### BACKGROUND

### Field of the Disclosure

The present disclosure relates to an image processing apparatus, a control method for the image processing apparatus, and a storage medium.

### Description of the Related Art

A document scanner is commonly used as a means for generating a digital document (hereinafter, referred to as “an electronic document”) by receiving, with a light receiving element, reflected light when optically scanning a paper document. Furthermore, a single-function scanner device, or a scanner unit or the like that has been mounted on a multifunctional peripheral is also able to be used as a document scanner. Hereinafter, these devices are collectively referred to as “reading devices”. In the reading device, when a paper document having a low-density achromatic color paper background (a low-density nearly white paper background) is converted into a digital document (an electronic document), for the paper background with a certain brightness or higher, a background color removal processing may be executed to turn the paper background white through signal processing. When the background color removal processing is executed, a contrast between the paper background, and characters (text) and the like becomes clear, and variations in reading signals due to unevenness of the paper surface are eliminated, improving the appearance of the electronic document. In addition, when the electronic document is subjected to data compression, by aligning the variations in the signals of the paper background, which occupies most of the area, to white, it is also possible to improve the compression efficiency.

Incidentally, regarding taxation-related business forms or the like, until now, only paper documents have been recognized as originals, but due to amendments to legal systems accompanying recent advances in electronic documentation technology, electronic documents are now also recognized as originals if they satisfy prescribed conditions. For example, under Law on Book and Record Keeping through Electronic Methods, that is, Electronic Books Maintenance Act (hereinafter, referred to as “electronic bookkeeping act”), the conditions for an electronic document to be recognized as an original include, for example, a condition that when a document is digitized (when a document is converted into an electronic document), white of a gradation pattern does not become completely white on the electronic document, and a condition that when a document is digitized, information on correction traces and the like will not be lost (visibility will be maintained).

However, when the above-described background color removal processing is executed, there are cases where the condition that the information on correction traces and the like will not be lost (hereinafter, also referred to as “a correction trace retaining condition”) is not satisfied. For example, in the case where a brightness of a correction trace is higher than a brightness that is a threshold value used as a boundary when the background color removal processing turns a specific pixel white, since the correction trace part will become completely white on the electronic document due to the background color removal processing, the correction trace retaining condition in the electronic bookkeeping act will not be satisfied. In order to deal with this issue, Japanese Laid-Open Patent Publication No. 2007-201827 discloses a technique for not executing the background color removal processing in order to express correction traces and the like by a read image.

However, simply not executing the background color removal processing may result in the correction trace part becoming completely white on the electronic document, depending on reading gradation characteristics of the reading device. In order to deal with this issue, Japanese Laid-Open Patent Publication No. 2006-295307 proposes a technique that suppresses (reduces) the amount of light irradiated when reading a document, reads the document darkly (hereinafter, this reading method is referred to as “dark reading”), and controls the paper background part so that the paper background part does not become completely white on the electronic document. Furthermore, there is also a product, in which a setting that allows electronic documents of taxation-related business forms or the like to be obtained is provided and in the case where a user has selected this setting, the dark reading is executed but the background color removal processing is not executed.

However, even in the above-described case of having been set so that the dark reading is executed but the background color removal processing is not executed, thereafter, the user may mistakenly change one of the settings, or may change one of the settings in conjunction with the setting of another function. In this case, since the correction trace retaining condition in the electronic bookkeeping act is not satisfied, there is an issue in that an electronic document different from the one desired by the user will be generated.

### SUMMARY

The present disclosure provides a mechanism capable of suppressing the disappearance of a correction trace when generating an electronic document from a document.

Accordingly, the present disclosure provides an image processing apparatus that comprises a reading unit configured to read a document and obtain read image data, an adjusting unit configured to convert a color of each of pixels having a brightness equal to or greater than a threshold value in the read image data into white, and an operation unit configured to be capable of performing at least a user operation regarding the reading unit and a user operation regarding the adjusting unit, the image processing apparatus comprising at least one processor, and a memory coupled to the processor storing instructions that, when executed by the processor, cause the processor to function as a first determining unit that determines whether or not a first predetermined operation has been performed by the operation unit, a reading mode setting unit that, in a case where the first determining unit determines that the first predetermined operation has been performed by the operation unit, sets a reading mode of the reading unit to a second reading mode in which the document is read under a darker condition than a first reading mode, a threshold value setting unit that, in the case where the first determining unit determines that the first predetermined operation has been performed by the operation unit, sets the threshold value of the adjusting unit to a second threshold value that is greater than a first threshold value, and a change-disabling unit that disables a change of the second reading mode that has been set by the reading mode setting unit and a change of the second threshold value that has been set by the threshold value setting unit.

According to the present disclosure, it is possible to suppress the disappearance of the correction trace when generating the electronic document from the document.

Further features of the present disclosure will become apparent from the following description of exemplary embodiments with reference to the attached drawings.

### BRIEF DESCRIPTION OF THE DRAWINGS

FIG. 1 is a schematic diagram that shows a system configuration related to a multifunction peripheral (hereinafter, referred to as “an MFP”) according to the present disclosure.

FIG. 2 is a block diagram that shows a detailed configuration of the MFP.

FIG. 3 is a sequence diagram that shows the flow of processing in the entire scan system in the MFP.

FIGS. 4A, 4B, and 4C are diagrams that show an example when a receipt has been read in a normal reading mode and an example when the receipt has been read in a dark reading mode.

FIGS. 5A, 5B, 5C, and 5D are diagrams for explaining the relationship between a background color removal level and a background color removal processing.

FIGS. 6A, 6B, 6C, and 6D are diagrams that show examples of each setting UI screen displayed on an operation unit of a first embodiment.

FIG. 7 is a flowchart that shows the flow from when an electronic document save mode is selected to when restricting of a UI operation is performed in the first embodiment.

FIG. 8 is a diagram that shows an example of a scan setting UI screen when restricting of a UI operation has been performed on the operation unit of the first embodiment.

FIGS. 9A, 9B, 9C, 9D, and 9E are diagrams that show examples of each setting UI screen displayed on an operation unit of a second embodiment.

FIG. 10 is a flowchart that shows the flow from when a correction trace disappearance prevention button is pressed to when restricting of a UI operation is performed in the second embodiment.

### DESCRIPTION OF THE EMBODIMENTS

The present disclosure will now be described in detail below with reference to the accompanying drawings showing embodiments thereof.

Hereinafter, embodiments of the present disclosure will be described in detail with reference to the accompanying drawings. However, the configuration described in each of the following embodiments is merely an example, and the scope of the present disclosure is not limited by the configuration described in each of the following embodiments. For example, each unit (each part) constituting the present disclosure can be replaced with a unit (a part) having an arbitrary configuration capable of exhibiting the similar function. In addition, arbitrary component(s) may be added. Furthermore, any two or more configurations (features) of each of the following embodiments may be combined.

### First Embodiment

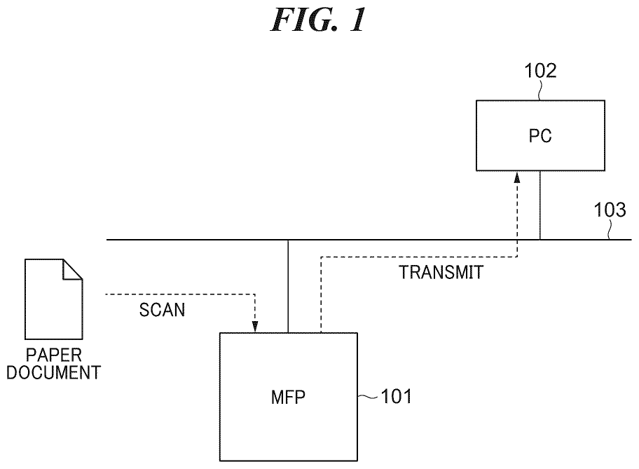

Hereinafter, a first embodiment will be described with reference to FIGS. 1 to 8.

### <Overall System Configuration>

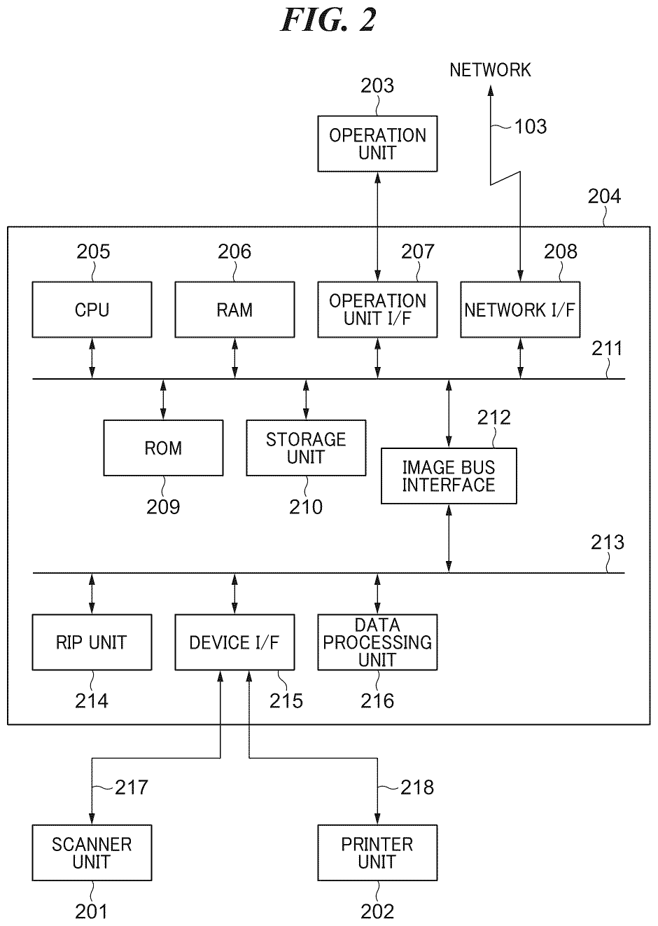

FIG. 1 is a schematic diagram that shows a system configuration related to an MFP 101. As shown in FIG. 1, the MFP 101 is connected to a personal computer (a PC) 102 via a network 103. A user is able to use an operation unit included in the MFP 101 (an operation unit 203 shown in FIG. 2 which will be described below) to perform various kinds of settings. Specifically, as the various kinds of settings, the user is able to perform settings of, for example, a resolution of image data, a compression rate, a data format (for example, joint photographic experts group (JPEG), tagged image file format (TIFF), portable document format (PDF), few-color compression, few-color compression (with optical character recognition (OCR) results), an e-document act mode), a transmission destination, etc. The MFP 101 generates image data by using software or hardware functions based on the various kinds of settings that have been set by the user, and transmits the generated image data to a destination (for example, the PC 102). It should be noted that the image data transmitted to the PC 102 is transmitted in a file format such as PDF, and therefore can be viewed by using a general-purpose viewer included in the PC 102.

### <Detailed Configuration of MFP>

FIG. 2 is a block diagram that shows a detailed configuration of the MFP 101. As shown in FIG. 2, the MFP 101 (an image processing apparatus) includes a scanner unit 201 (a reading unit), a printer unit 202, the operation unit 203 (an operation unit), and a control unit 204. The scanner unit 201 is an image input device. The printer unit 202 is an image output device. The operation unit 203 is a user interface (a UI) such as a touch panel. Therefore, the user is able to perform UI operations on UI screens of the operation unit 203. The scanner unit 201, the printer unit 202, and the operation unit 203 are connected to the control unit 204. Furthermore, the control unit 204 performs input/output of image information and device information by being connected to the network 103.

The control unit 204 includes a central processing unit (a CPU) 205, a random access memory (a RAM) 206, an operation unit interface (an operation unit I/F) 207, a network I/F 208, a read only memory (a ROM) 209, a storage unit 210, and a system bus 211. Furthermore, the control unit 204 includes an image bus interface 212, an image bus 213, a raster image processor unit (a RIP unit) 214, a device I/F unit 215, and a data processing unit 216. The CPU 205 is a processor that controls the entire MFP 101. The RAM 206 is a working memory for the CPU 205 to work, and is also an image memory for temporarily storing image data.

The operation unit I/F 207 is an interface unit with the operation unit 203, and outputs, to the operation unit 203, image data to be displayed on the operation unit 203. In addition, the operation unit I/F 207 outputs information, which has been inputted by the user of the MFP 101 through a UI operation on the operation unit 203, to the CPU 205. The network I/F 208 connects the MFP 101 to the network 103 and performs input/output of information in packet format. The ROM 209 is a boot ROM, and stores programs such as a boot program. The storage unit 210 is a hard disk drive, and stores control software, image data, etc. The CPU 205, the RAM 206, the operation unit I/F 207, the network I/F 208, the ROM 209, and the storage unit 210 are connected to each other via the system bus 211.

The image bus interface 212 is a bus bridge that connects the system bus 211 and the image bus 213 and converts data structure. The image bus 213 transfers image data at high speed, and is configured by, for example, a peripheral component interconnect bus (a PCI bus) or an IEEE1394 bus. The RIP unit 214, the device I/F unit 215, and the data processing unit 216 are connected to the image bus 213. The RIP unit 214 executes a so-called rendering processing that analyzes page description language codes (PDL codes) of print data received from the PC 102 or the like and develops them into a bitmap image with a set resolution. The device I/F unit 215 is connected to the scanner unit 201, which is the image input device, via a signal line 217, and is connected to the printer unit 202, which is the image output device, via a signal line 218.

The data processing unit 216 executes image processing of image data (hereinafter, referred to as “scanned data”) inputted from the scanner unit 201 and data processing of print image(s) to be outputted to the printer unit 202, and also executes processing such as the few-color compression and the OCR. In addition, the data processing unit 216, as described below, generates image data that satisfies the correction trace retaining condition in the electronic bookkeeping act, that is, generates an electronic document that satisfies the correction trace retaining condition in the electronic bookkeeping act. The generated electronic document is transmitted to a set destination (for example, the PC 102) via the network I/F 208 and the network 103. It should be noted that the MFP 101 that has been described with reference to FIG. 2 is merely an example, and may include configurations (components) not shown in FIG. 2 as necessary, or may not include some of the configurations (the components) shown in FIG. 2.

### <Flow of Processing in Entire Scan System in MFP>

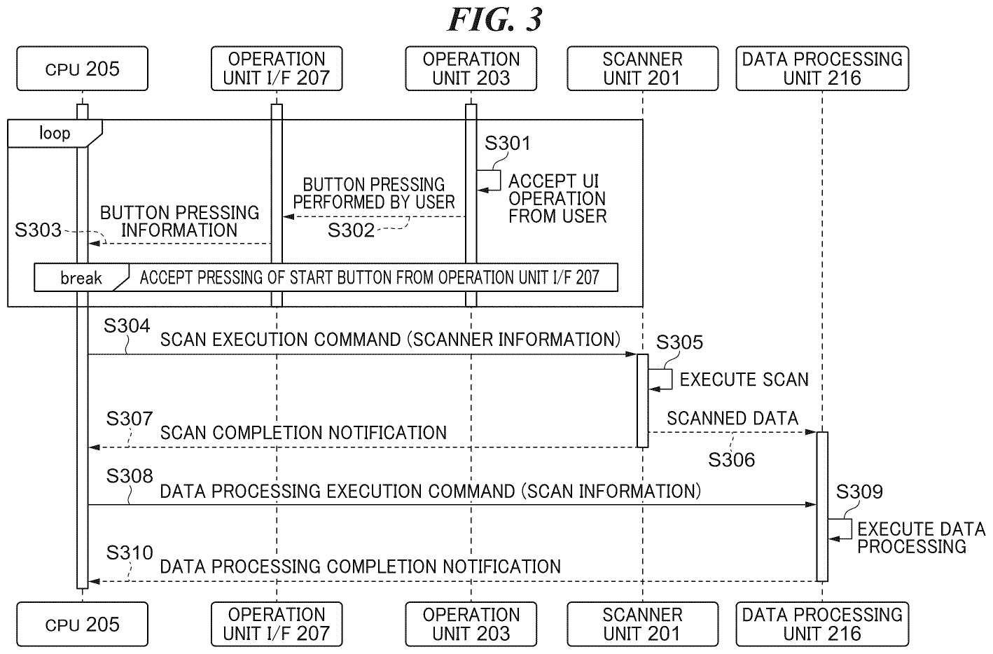

FIG. 3 is a sequence diagram that shows the flow of processing in the entire scan system in the MFP 101. Respective steps shown in FIG. 3 are realized in the MFP 101 by the CPU 205 reading a program, which has been stored in the storage unit 210, into the RAM 206 and executing the program. First, in a step S301, the CPU 205 causes the operation unit 203 to accept UI operations from the user. As a result, the user is able to use the operation unit 203 to perform a scan setting. In the scan setting, for example, it is possible to perform a plurality of settings such as color selection, a reading magnification, a document type, a reading mode, and a background color removal level. It should be noted that the details of the scan setting will be described in <Scan setting and UI operation> that will be described below.

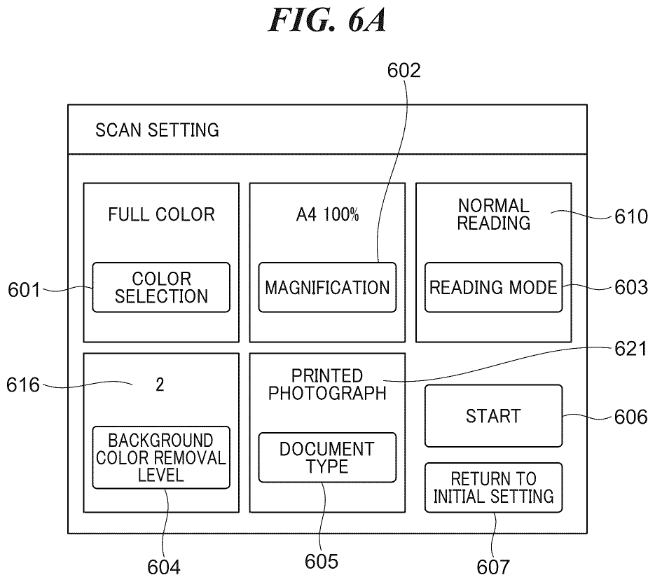

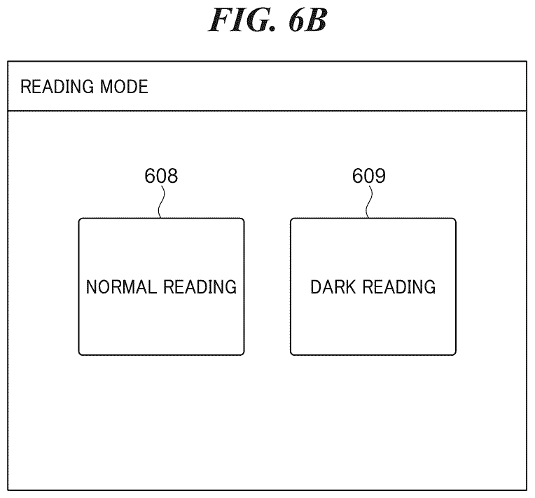

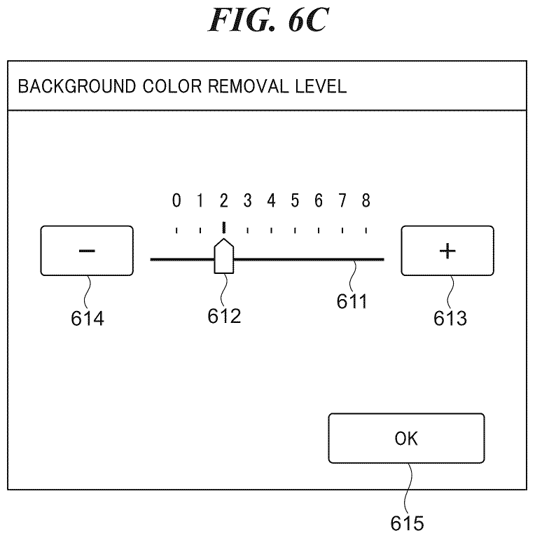

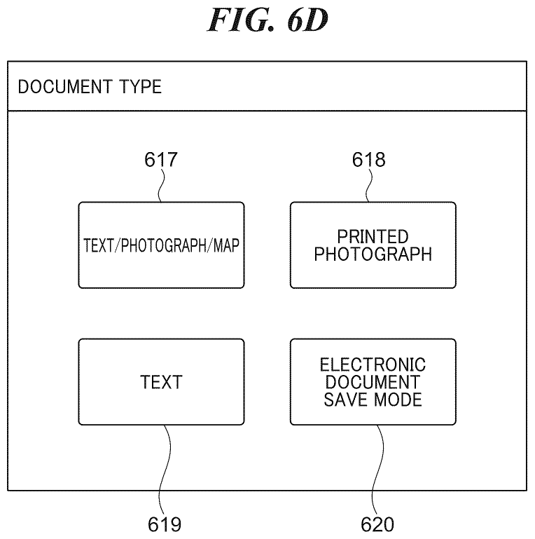

In steps S302 and S303, the CPU 205 receives, via the operation unit I/F 207, button pressing information when the user has performed the UI operations on the operation unit 203. At this time, the CPU 205 retains respective values of the scan setting in the RAM 209 based on the received button pressing information. It should be noted that the CPU 205 continues to cause the operation unit 203 to accept the UI operations from the user until a start button (a start button 606 shown in FIG. 6A, which will be described below) is pressed. Then, when the CPU 205 receives start button pressing information via the operation unit I/F 207, the processing proceeds to a step S304.

In the step S304, the CPU 205 transmits, to the scanner unit 201, a command to execute scanning (a scan execution command). At this time, the CPU 205 simultaneously transmits, to the scanner unit 201, information necessary for the scanner unit 201 to execute scanning, among the respective values of the scan setting (hereinafter, referred to as “scanner information”). It should be noted that the scanner information also includes information about the reading mode, etc., which have been set by the user through the UI operations in the step S301. In a step S305, the CPU 205 generates scanned data by causing the scanner unit 201 to scan a document based on the scanner information.

In a step S306, the CPU 205 causes the scanner unit 201 to transmit, to the data processing unit 216, the scanned data that has been generated in the step S305. In a step S307, the CPU 205 receives, from the scanner unit 201, a notification indicating that the scan processing has been completed (a scan completion notification). In a step S308, in order to execute the image processing of the scanned data, the CPU 205 transmits, to the data processing unit 216, a command to execute the data processing (a data processing execution command). At this time, the CPU 205 simultaneously transmits, to the data processing unit 216, information necessary for the data processing unit 216 to execute the image processing of the scanned data, among the respective values of the scan setting (hereinafter, referred to as “scan information”). It should be noted that the scan information also includes information about the background color removal level, etc., which have been set by the user through the UI operations in the step S301.

In a step S309, the CPU 205 causes the data processing unit 216 to process the scanned data (read image data) that has been received from the scanner unit 201 based on the scan information that has been received from the CPU 205. It should be noted that the CPU 205 also causes the data processing unit 216 (an adjusting unit) to execute a background color removal processing in the step S309. In a step S310, the CPU 205 receives, from the data processing unit 216, a notification indicating that the data processing has been completed (a data processing completion notification). The above is the description of the sequence that shows the flow of the processing in the entire scan system in the MFP 101.

### <Scan Setting and UI Operation>

As described above, in the scan setting, for example, it is possible to perform the plurality of settings such as the color selection, the reading magnification, the document type, the reading mode, and the background color removal level. The color selection is a setting item regarding color/monochrome when saving or copying the scanned data. The reading magnification is a setting item regarding enlargement/reduction of the scanned data. The document type is a setting item regarding the type of a document to be scanned. The reading mode is a setting item regarding an amount of light irradiated (an irradiation light amount) when the scanner unit 201 reads a document, and in the first embodiment, there are two modes: “a normal reading mode”, in which a document is read with a normal amount of light irradiated (a normal irradiation light amount), and “a dark reading mode”, in which a document is read with an irradiation light amount that is less than the normal irradiation light amount.

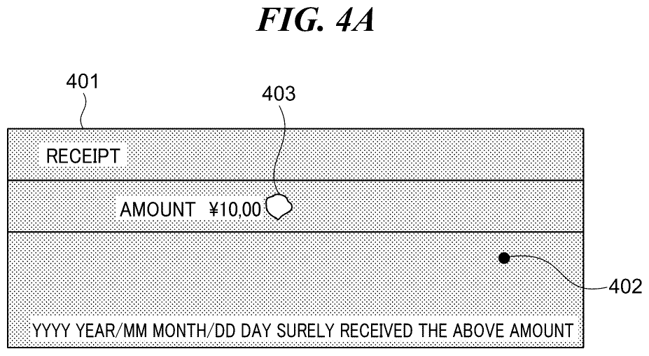

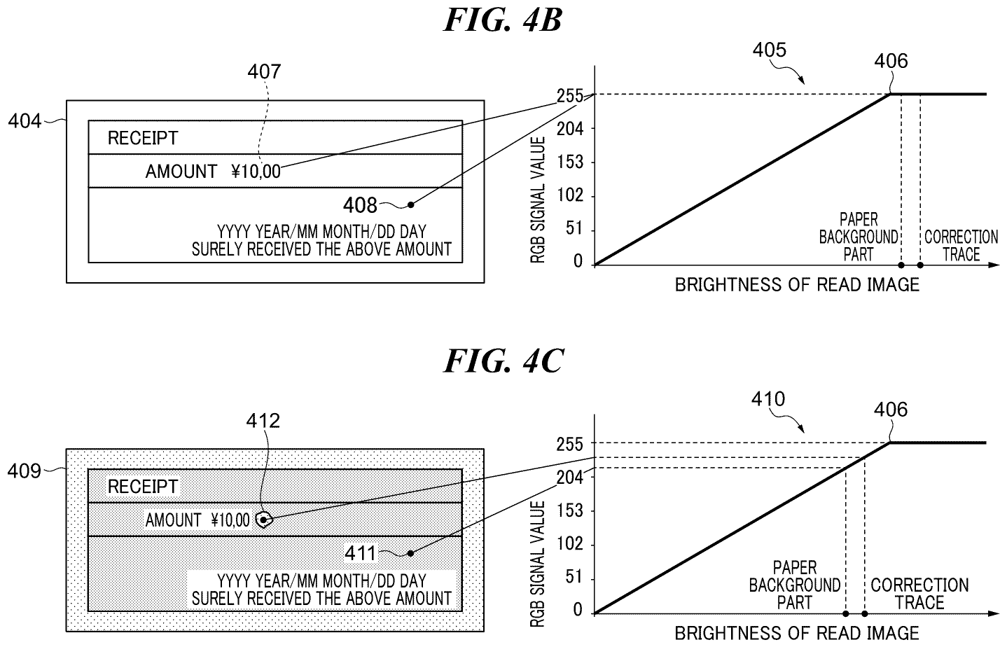

FIGS. 4A, 4B, and 4C are diagrams that show an example when a receipt has been read in the normal reading mode (a first reading mode) and an example when the receipt has been read in the dark reading mode (a second reading mode). Reference numeral 401 in FIG. 4A denotes an original document of the receipt (hereinafter, referred to as “a receipt document”). The receipt document 401 includes a paper background part 402 and a correction trace part 403. Reference numeral 404 in FIG. 4B denotes a read image obtained when the receipt document 401 has been read in the normal reading mode. Reference numeral 405 in FIG. 4B denotes a graph that shows a conversion characteristic from a brightness of the read image 404 to an RGB signal value. The graph 405 has the brightness of the read image 404 on the horizontal axis and the RGB signal value on the vertical axis, and shows a reading gradation characteristic when the brightness of the receipt document 401 that has been read in the normal reading mode is converted into the RGB signal value.

As shown in the graph 405, a brightness equal to or greater than a certain value 406 is converted to white (the RGB signal value=255). In the example of FIG. 4B, the brightness of both the paper background part 402 and the correction trace part 403 in the receipt document 401 exceeds the certain value 406, and therefore is converted to white (255) in the RGB signal value. Therefore, in the read image 404, the paper background part 402 and the correction trace part 403 in the receipt document 401 become completely white, and a correction trace part 407 is buried in a paper background part 408 and disappears. In this case, the read image 404 does not satisfy the condition that “white of the gradation pattern does not become completely white on the electronic document” and the condition that “the information on correction traces and the like will not be lost”, and therefore becomes a read image that is not recognized under the electronic bookkeeping act.

Reference numeral 409 in FIG. 4C denotes a read image obtained when the receipt document 401 has been read in the dark reading mode. Reference numeral 410 in FIG. 4C denotes a graph that shows a conversion characteristic from a brightness of the read image 409 to the RGB signal value. The graph 410 can be viewed in the same way as the graph 405 in the normal reading mode. In the case where the receipt document 401 has been read in the dark reading mode, since the irradiation light amount is reduced compared to the normal reading mode, the brightness of the paper background part and the correction trace part in the graph 410 is lower than that in the graph 405 (shifting to the left on the graph 410). As a result, since the brightness of the paper background part 402 and the correction trace part 403 in the receipt document 401 becomes smaller than the certain value 406, neither of them becomes white (255) in the RGB signal value, and information other than white is retained. Therefore, in the read image 409, neither a paper background part 411 nor a correction trace part 412 becomes white, and the visibility is maintained. Therefore, the read image 409 becomes a read image that satisfies the conditions of the electronic bookkeeping act.

It should be noted that in the dark reading mode of FIG. 4C, the document 401 is irradiated with the light amount obtained by reducing 10% from the light amount of FIG. 4B. However, the 10% reduction here is merely an example, and is a value that should be changed in design depending on the reader or the brightness of the remaining correction trace part. In addition, it is also possible to achieve dark reading by controlling a light receiving sensitivity and/or a light receiving time rather than the irradiation light amount. In other words, in the dark reading mode, the light receiving sensitivity is lowered and/or the light receiving time is shortened compared to the normal reading mode, thereby achieving dark reading.

Next, the background color removal level will be described. The background color removal level is a setting item regarding which brightness to be converted to white in the background color removal processing. In the first embodiment, the value of the background color removal level is set to a value ranging from 0 to 8, and it is defined so that the lower the value of the background color removal level is, the larger a threshold value for making the pixel white becomes. Therefore, in the case where the value of the background color removal level is low, since the threshold value is large, the number of pixels converted to white will decrease, whereas in the case where the value of the background color removal level is high, since the threshold value is small, the number of pixels converted to white will increase. In addition, a case where the value of the background color removal level is 0 that is the lowest value becomes the same as a case where the background color removal processing is not executed. Therefore, in the case where the value of the background color removal level is 0 that is the lowest value, the background color removal processing is not executed.

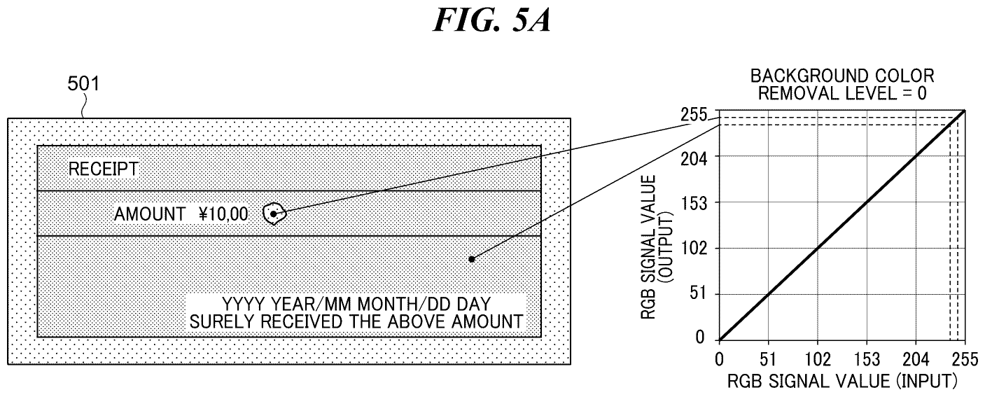

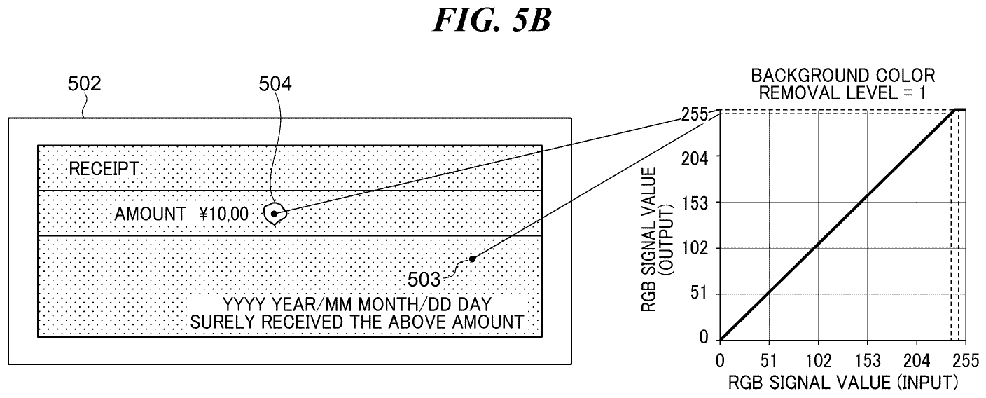

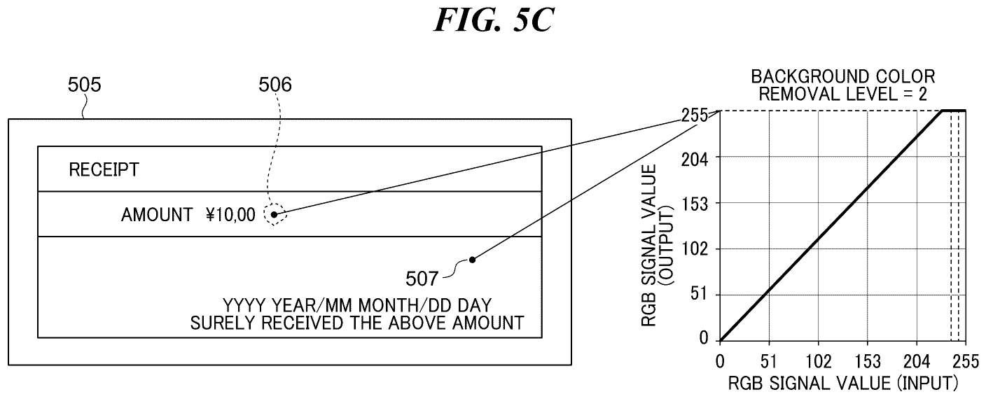

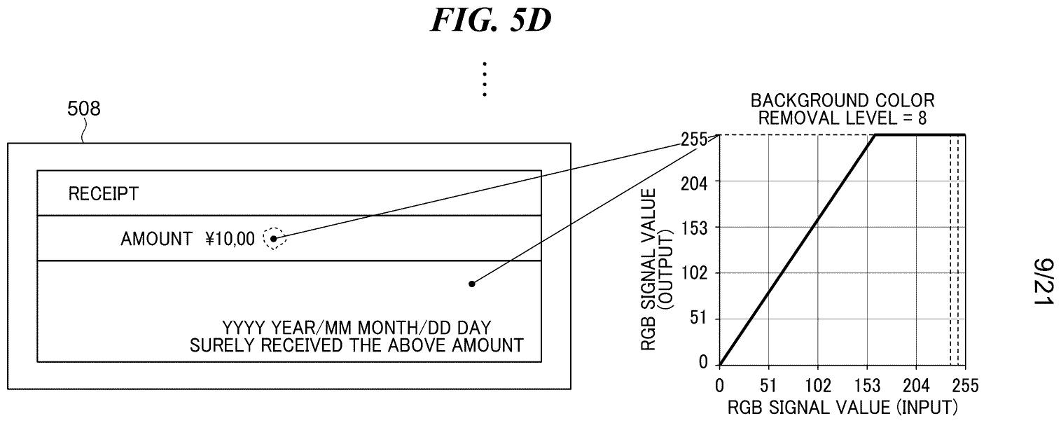

The relationship between the background color removal level and the background color removal processing will be described below with reference to FIGS. 5A, 5B, 5C, and 5D. The left side of each of FIGS. 5A, 5B, 5C, and 5D shows an image (referred to as “an output image” only when describing FIGS. 5A, 5B, 5C, and 5D) obtained after the background color removal processing has been executed on the read image 409 (referred to as “an input image” only when describing FIGS. 5A, 5B, 5C, and 5D) of the receipt document 401 obtained in the dark reading mode. Here, the cases where the values of the background color removal level are 0, 1, 2, and 8 will be given as examples. In addition, in each of FIGS. 5A, 5B, 5C, and 5D, the right side of the output image shows a graph of input/output in the background color removal processing corresponding to the output image (hereinafter, referred to as “an input/output graph”). In each input/output graph, the horizontal axis represents the RGB signal value of the input image, and the vertical axis represents the RGB signal value of the output image, showing how the input signal is converted into the output signal by the background color removal processing. FIG. 5A shows an example in which the value of the background color removal level is 0. The threshold value in the case where the value of the background color removal level is 0 is set to 255, which is equal to a value of the brightness indicating white. As a result, since the case where the value of the background color removal level is 0 is the case where the background color removal processing is not executed, the input/output graph is also a straight line, meaning that the input signal is outputted as is. Therefore, an output image 501 becomes the same as the input image.

FIG. 5B shows an example in which the value of the background color removal level is 1. As described above, the lower the value of the background color removal level is, the larger the threshold value becomes, here, as an example, the threshold value in the case where the value of the background color removal level is 1 is set to 241. Therefore, according to the input/output graph, all RGB signal values of the input image that are 241 or greater are converted to 255 (white) by the background color removal processing. Since the RGB signal values of the paper background part of the input image are smaller than 241, as shown in a paper background part 503 of an output image 502, the RGB signal values of the paper background part of the input image do not become white, and information other than white is retained. However, since the RGB signal values of the correction trace part of the input image exceed 241, as shown in a correction trace part 504 of the output image 502, the RGB signal values of the correction trace part of the input image become 255 (white). In this case, the output image 502 is not able to satisfy the condition of the electronic bookkeeping act that “white does not become completely white on the electronic document”.

FIG. 5C shows an example in which the value of the background color removal level is 2. Here, as an example, the threshold value in the case where the value of the background color removal level is 2 is set to 231. Therefore, in the input/output graph, all RGB signal values of the input image that are 231 or greater are converted to 255 (white) by the background color removal processing. The RGB signal values of the paper background part and the correction trace part of the input image are both greater than the threshold value, and are therefore converted to 255 (white). Therefore, in an output image 505, a correction trace part 506 is buried in a paper background part 507 and disappears. In this case, the output image 505 is not able to satisfy the condition of the electronic bookkeeping act that “the information on correction traces and the like will not be lost”.

FIG. 5D shows an example in which the value of the background color removal level is 8. Here, as an example, the threshold value in the case where the value of the background color removal level is 8 is set to 162. Same as the case where the value of the background color removal level is 2 (FIG. 5C), since the RGB signal values of the paper background part and the correction trace part of the input image are both greater than the threshold value of 162, an output image 508 is similar to the case where the value of the background color removal level is 2 (FIG. 5C). Therefore, the output image 508 is not able to satisfy the condition of the electronic bookkeeping act that “the information on correction traces and the like will not be lost”. However, in the input/output graph, since the threshold value has been reduced, the linear portion below the threshold value is steeper than the case where the value of the background color removal level is 2 (FIG. 5C). As a result, in the case where the value of the background color removal level is 8, by increasing the value of the background color removal level, the output image 508 becomes brighter overall. It should be noted that, in the case where the value of the background color removal level is set to 3 to 7, since the tendency is basically the same as in the case where the value of the background color removal level is set to 2 or 8, the description thereof will be omitted.

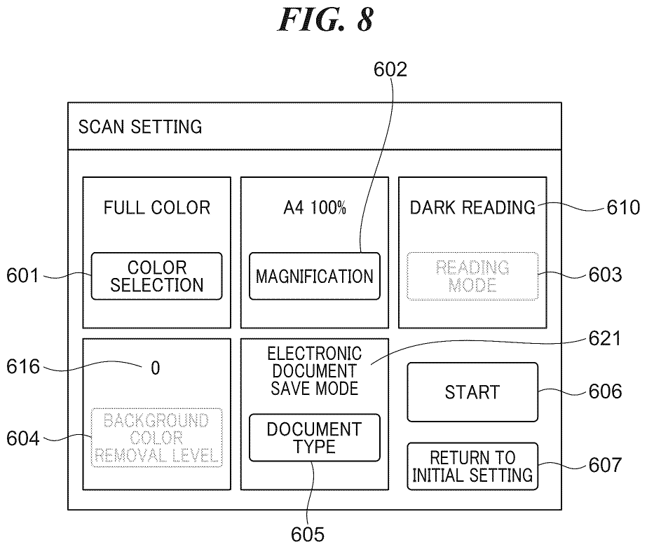

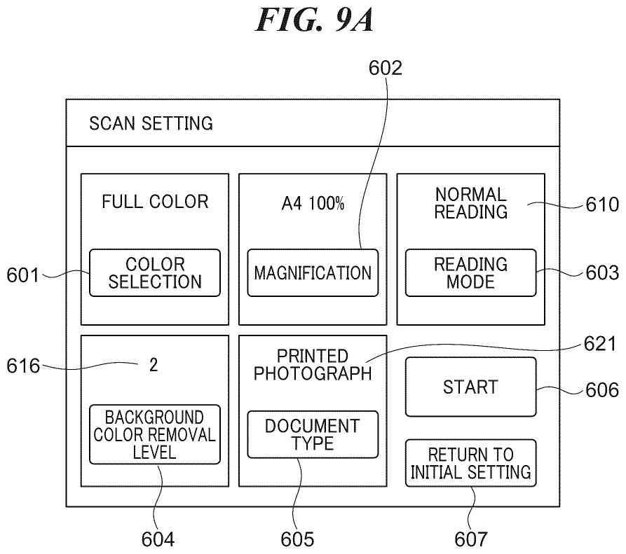

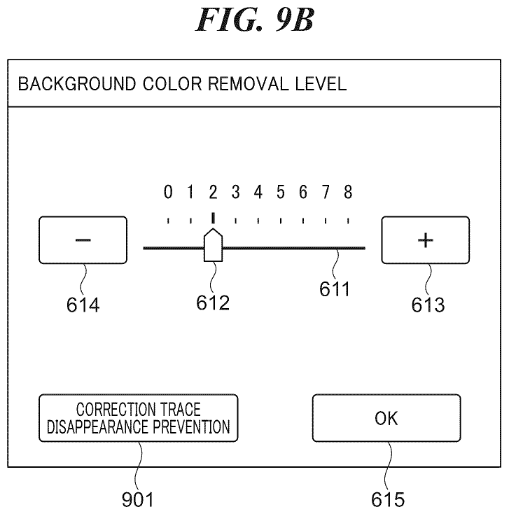

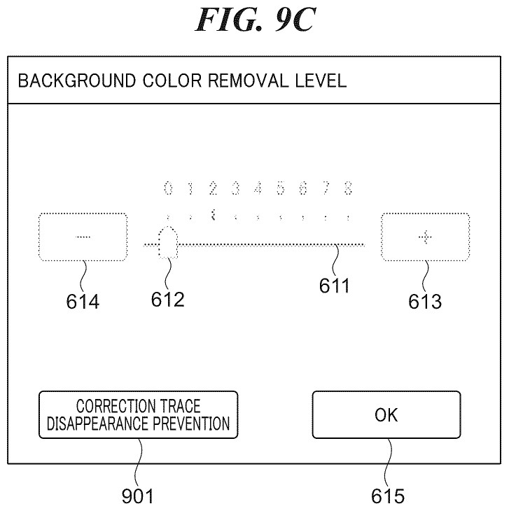

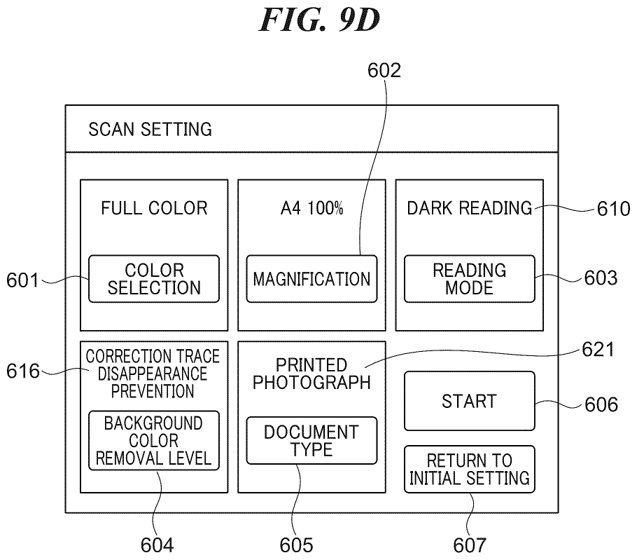

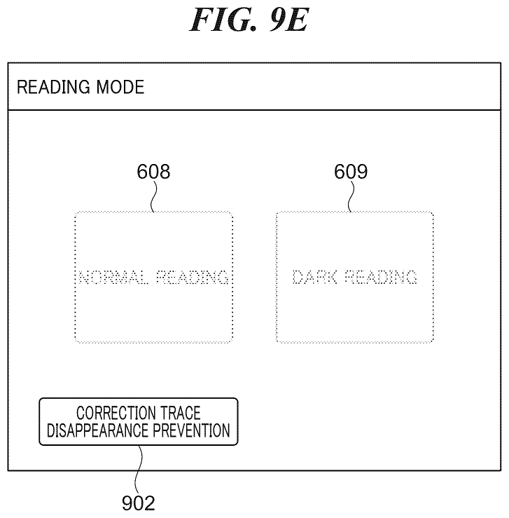

In the scan setting of the first embodiment, when the document type is set to an electronic document save mode, the setting of the reading mode and the setting of the background color removal level are changed, and further, UI operations on the operation unit 203 are restricted. FIGS. 6A, 6B, 6C, and 6D are diagrams that show examples of each setting UI screen displayed on the operation unit 203 of the first embodiment. The setting UI screens shown in FIGS. 6A, 6B, 6C, and 6D are displayed on the operation unit 203 by the CPU 205 (a UI screen display unit) via the operation unit I/F 207. This also applies to each setting UI screen shown in FIGS. 8, 9A, 9B, 9C, 9D, and 9E that will be described below. FIG. 6A is a diagram that shows an example of a scan setting UI screen displayed on the operation unit 203. The scan setting UI screen of FIG. 6A displays buttons 601 to 605 for transitioning to each setting UI screen for the color selection, the magnification, the reading mode, the background color removal level, and the document type, as well as the start button 606 for starting reading by scanning. The scan setting UI screen of FIG. 6A further displays a button 607 for returning various kinds of settings to their initial values.

FIG. 6B shows an example of a reading mode setting UI screen to which the screen transitions from the scan setting UI screen after the button 603 has been pressed. The reading mode setting UI screen of FIG. 6B displays buttons 608 and 609 corresponding to the normal reading mode and the dark reading mode, respectively. It should be noted that in the first embodiment, as one of the values of the scan setting, a reading mode flag, which sets the normal reading mode to 0 and sets the dark reading mode to 1, is retained. It should be noted that, as described above, when the user presses the button, the respective values of the scan setting associated with the setting change made through the UI operation are retained in the RAM 209 by the CPU 205.

Therefore, when the button 608 corresponding to the normal reading mode is pressed on the reading mode setting UI screen, the CPU 205 sets the value of the reading mode flag to 0, and when the button 609 corresponding to the dark reading mode is pressed on the reading mode setting UI screen, the CPU 205 sets the value of the reading mode flag to 1. As described above, the button 603 is a button that the user operates to start the setting of the reading mode. The buttons 608 and 609 are buttons that the user operates to set the reading mode. In addition, in a reading mode display part 610 on the scan setting UI screen of FIG. 6A, characters based on the value of the reading mode flag are displayed. As a result, the name of one of the reading modes (that is, “normal reading” or “dark reading”) is displayed on the reading mode display part 610. It should be noted that in the first embodiment, it is assumed that the normal reading mode has been set as the default.

FIG. 6C shows an example of a background color removal level setting UI screen to which the screen transitions from the scan setting UI screen after the button 604 has been pressed. The background color removal level setting UI screen of FIG. 6C displays a gauge 611 indicating the value of the background color removal level in nine steps from 0 to 8, and a mark 612. In the gauge 611, the further to the left the value of the background color removal level becomes smaller, and the further to the right the value of the background color removal level becomes larger. In the example of FIG. 6C, since the mark 612 on the gauge 611 is located third from the left, the value of the background color removal level has been set to 2.

A “+” button 613, a “−” button 614, and an OK button 615 are displayed on the background color removal level setting UI screen. The user is able to arbitrarily change or set the value of the background color removal level by pressing the “+” button 613 or the “−” button 614. When he “+” button 613 is pressed, the mark 612 moves to the right, and when the “−” button 614 is pressed, the mark 612 moves to the left. In the case where the mark 612 is located at the leftmost position, the value of the background color removal level becomes 0, which means the case where the background color removal processing is not executed. When the user presses the OK button 615, the background color removal level setting UI screen transitions to the scan setting UI screen of FIG. 6A. As described above, the button 604 is a button that the user operates to start the setting of the value of the background color removal level (that is, the setting of the threshold value). The “+” button 613 and the “−” button 614 are buttons that the user operates to set the value of the background color removal level (that is, the threshold value).

In the first embodiment, as one of the values of the scan setting, the value of the background color removal level corresponding to the position of the mark 612 is retained in the RAM 209 by the CPU 205. At this time, characters based on the value of the background color removal level are displayed in a background color removal level display part 616 on the scan setting UI screen of FIG. 6A. As a result, one of the values of the background color removal level (that is, one of 0 to 8) is displayed on the background color removal level display part 616. It should be noted that in the example of FIG. 6C, the value of the background color removal level that has been retained in the RAM 209 by the CPU 205 is 2.

FIG. 6D shows an example of a document type setting UI screen to which the screen transitions from the scan setting UI screen after the button 605 has been pressed. The document type setting is a function for switching to image processing prepared in advance for each document type in accordance with the document type that has been set by the user. The document type setting UI screen of FIG. 6D displays buttons 617 to 620 corresponding to typical document types. The user is able to use the buttons 617 to 620 to select and set one of “text/photograph/map”, “printed photograph”, “text”, and “electronic document save mode” as the document type.

The button 617 is a button corresponding to a document on which various kinds of contents such as text, photographs, maps, etc. have been arranged. In the case where the user has pressed the button 617, “text/photograph/map” is selected as the document type. In this case, it is set so that the image processing to separate scanned data of the document into individual contents (text, photographs, or maps) is executed, and further, a filter processing, etc., which are suitable for each separated area, are executed.

The button 618 is a button corresponding to a document mainly including photographs. In the case where the user has pressed the button 618, “printed photograph” is selected as the document type. In this case, it is set so that a filter processing, color conversion, etc., which are suitable for a document mainly including photographs are executed. The button 619 is a button corresponding to a document that is mainly text. In the case where the user has pressed the button 619, “text” is selected as the document type. In this case, it is set so that a filter processing, color conversion, etc., which are suitable for a document that is mainly text are executed. Specifically, in the case where the button 619 corresponding to characters (text) has been pressed, for example, in order to improve the readability of the characters, it is set so that a filter processing that emphasizes the edges of the characters is executed.

The button 620 is a button corresponding to the electronic document save mode. In the case where the user has pressed the button 620, “electronic document save mode” is selected as the document type. In the case where the user makes an electronic document compliant with the electronic bookkeeping act, the user presses the button 620. In this case, in order to guarantee the conditions of the electronic bookkeeping act, it is set so that unnecessary image processing such as the color conversion and the filter processing is not executed. As described above, the button 620 is a button that the user operates to set the electronic document save mode (that is, the electronic document) as the document type. It should be noted that, in a document type display part 621 on the scan setting UI screen of FIG. 6A, characters based on which of the buttons 617 to 620 has been pressed by the user are displayed.

It should be noted that in the first embodiment, as described above, in the case where the button 620 corresponding to the electronic document save mode has been pressed, in order to satisfy the correction trace retaining condition in the electronic bookkeeping act, the value of the reading mode flag and the value of the background color removal level are changed or set. Specifically, in order to execute dark reading and not to execute the background color removal processing, the CPU 205 sets the value of the reading mode flag to 1 and sets the value of the background color removal level to 0. The above is the description of the scan setting and the UI operations in the first embodiment.

### <Restricting of UI Operation in Electronic Document Save Mode>

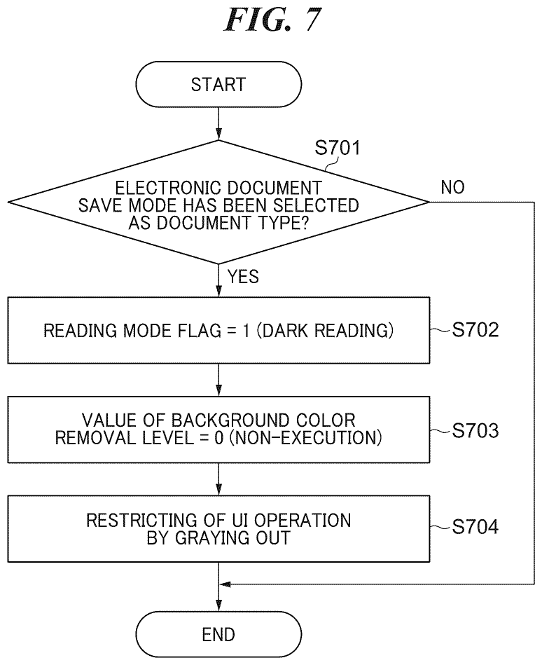

Even in the case where the user selects the electronic document save mode on the document type setting UI screen of FIG. 6D, the reading mode and the background color removal level, which are related to the correction trace retaining condition in the electronic bookkeeping act, may be changed or set unexpectedly afterwards. In this case, by means of the MFP 101, an electronic document, which does not satisfy the correction trace retaining condition in the electronic bookkeeping act, will be generated. Therefore, in the case where the electronic document save mode has been selected on the operation unit 203, in order to prevent the settings related to the correction trace retaining condition in the electronic bookkeeping act from being changed, restricting of the UI operation is performed. Hereinafter, restricting of the UI operation on the operation unit 203 will be described with reference to FIG. 7 and FIG. 8.

FIG. 7 is a flowchart that shows the flow from when the electronic document save mode is selected to when restricting of the UI operation is performed. Respective steps (a control method for the image processing apparatus) of the flowchart shown in FIG. 7 are realized in the MFP 101 by the CPU 205 (a computer) reading a program, which has been stored in the storage unit 210, into the RAM 206 and executing the program. In the flowchart shown in FIG. 7, first, in a step S701, the CPU 205 (a first determining unit) determines whether or not the electronic document save mode has been selected as the document type (a determining step).

In other words, the CPU 205 determines whether or not pressing (a first predetermined operation) of the button 620 (a first predetermined button) corresponding to the electronic document save mode has been performed. In the case where the pressing of the button 620 corresponding to the electronic document save mode has been performed, the CPU 205 determines that the electronic document save mode has been selected as the document type. In this case, the processing proceeds to a step S702. On the other hand, in the case where the pressing of the button 620 corresponding to the electronic document save mode has not been performed, the CPU 205 determines that the electronic document save mode has not been selected as the document type. In this case, the flowchart shown in FIG. 7 ends.

In the step S702, the CPU 205 (a reading mode setting unit) sets the value of the reading mode flag to 1 in order to execute dark reading (a reading mode setting step). In a step S703, the CPU 205 (a threshold value setting unit) sets the value of the background color removal level to 0 in order not to execute the background color removal processing (a threshold value setting step). As a result, the threshold value in the background color removal processing is set to a value equal to the value of the brightness indicating white, for example, 255. It should be noted that in this case, 255 corresponds to a second threshold value, and a value less than 255 corresponds to a first threshold value. In a step S704, the CPU 205 (a change-disabling unit) restricts the UI operation on the scan setting UI screen displayed on the operation unit 203, thereby disabling the setting change of the reading mode and the background color removal level (a change-disabling step). Specifically, the CPU 205 performs operation restriction by graying out the button 603 (a first start button) corresponding to the reading mode and the button 604 (a second start button) corresponding to the background color removal level, thereby disabling input via the button 603 and the button 604. Thereafter, the flowchart shown in FIG. 7 ends.

FIG. 8 is a diagram that shows an example of the scan setting UI screen when restricting of the UI operation has been performed on the operation unit 203. In the first embodiment, as described above, as a method for disabling the setting change of the reading mode and the background color removal level, disabling input by graying out (disabling input based on grayed-out) is adopted. As shown in FIG. 8, on the scan setting UI screen when restricting of the UI operation has been performed, the button 603 corresponding to the reading mode and the button 604 corresponding to the background color removal level are grayed out to prevent the user from pressing them. This prevents the scan setting UI screen from transitioning to the reading mode setting UI screen or the background color removal level setting UI screen, thereby preventing the user from changing the settings of the reading mode and the background color removal level.

At this time, the characters based on the value of the reading mode flag are displayed on the reading mode display part 610, and the characters based on the value of the background color removal level are displayed on the background color removal level display part 616. In the first embodiment, in the case where the electronic document save mode has been selected on the document type setting UI screen, as described in the description of the steps S702 and S703, the value of the reading mode flag is set to 1 and the value of the background color removal level is set to 0. Therefore, as shown in FIG. 8, the reading mode display part 610 displays “dark reading”, and the background color removal level display part 616 displays “0”. In addition, the selected “electronic document save mode” is displayed on the document type display part 621.

It should be noted that in the case where the user has selected a type other than the electronic document save mode (for example, “text/photograph/map”, “printed photograph”, or “text”) as the document type on the document type setting UI screen, the CPU 205 cancels disabling input by graying out to be performed in the step S704. In other words, in the case where the CPU 205 (a second determining unit) determines that pressing (a second predetermined operation) of any one of the multiple buttons 617 to 619 (second predetermined buttons) on the document type setting UI screen (FIG. 6D) has been performed, the CPU 205 (a cancelling unit) cancels the operation restriction to be performed in the step S704. As a result, the user is able to cancel the operation restriction to be performed in the step S704 simply by performing an operation of pressing any one of the multiple buttons 617 to 619 other than the button 620 corresponding to the electronic document save mode. The above is the description of restricting of the UI operation on the operation unit 203. In this way, the MFP 101 is able to prevent unexpected setting changes by graying out the button 603 and the button 604 that allow changes to be made to the settings related to the correction trace retaining condition in the electronic bookkeeping act.

As described above, in the first embodiment, in the case where the electronic document save mode has been selected in the MFP 101, dark reading is executed and the background color removal processing is not executed, while restricting of the UI operation is performed by means of disabling input by graying out. As a result, when generating an electronic document from a document, the MFP 101 is able to suppress the disappearance of the correction trace due to the reading mode and/or the background color removal processing. In addition, the user is able to cause the MFP 101 to generate, from a document, an electronic document in which the disappearance of the correction trace has been suppressed simply by performing an operation of pressing the button 620 corresponding to the electronic document save mode.

### Second Embodiment

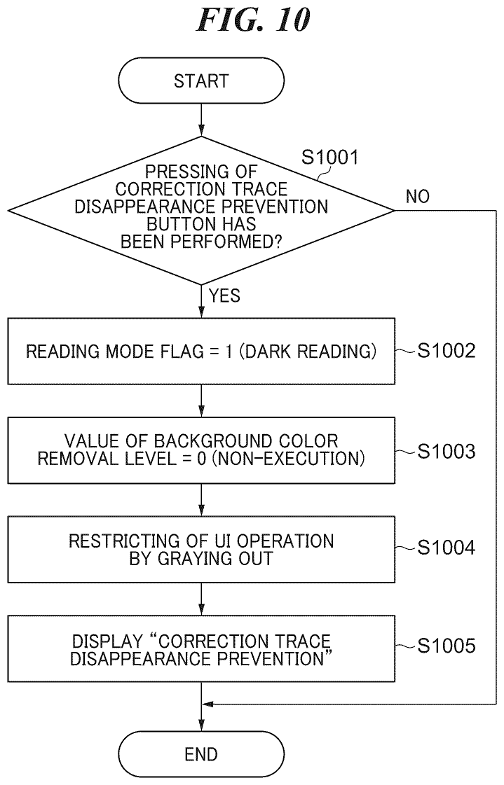

Hereinafter, a second embodiment will be described with reference to FIGS. 9A, 9B, 9C, 9D, 9E, and 10. Here, the differences from the first embodiment will be mainly described. In the first embodiment, in the case where the electronic document save mode has been selected as the document type, the reading mode and the background color removal level have been appropriately set to satisfy the correction trace retaining condition in the electronic bookkeeping act, and then the UI operation has been restricted to prevent unexpected UI operations from being performed. However, in the first embodiment, when a type other than the electronic document save mode is selected as the document type, it has not been possible to use the function that satisfies the correction trace retaining condition in the electronic bookkeeping act (that is, it has not been possible to execute the respective processes from the step S702 to the step S704).

For example, in the case of scanning and saving a cadastral map (an official map) necessary for land purchases and sales, in order to cause to apply an appropriate filter processing and an appropriate color processing to the cadastral map, the user will often select “text/photograph/map” as the document type. However, for official maps necessary for land purchases and sales, same as the case where the electronic document save mode has been selected, it should be possible to determine the presence or absence of correction traces. Therefore, in the second embodiment, in addition to the button 620 corresponding to the electronic document save mode, a button for causing to make an electronic document compliant with the electronic bookkeeping act is provided. As a result, even in the case where a type other than the electronic document save mode has been selected as the document type, it is possible to realize the restricting of the UI operation for correction trace retaining.

It should be noted that in the second embodiment, the overall system configuration, the detailed configuration of the MFP 101, and the flow of the processing in the entire scan system in the MFP 101 are common to the first embodiment, so descriptions thereof will be omitted. Furthermore, in the second embodiment, the same reference numerals are used to designate the same or similar configurations as those in the first embodiment, and redundant descriptions will be omitted.

### <Scan Setting and UI Operation>

FIGS. 9A, 9B, 9C, 9D, and 9E are diagrams that show examples of each setting UI screen displayed on an operation unit 203 of the second embodiment. FIG. 9A is a diagram that shows an example of a scan setting UI screen displayed on the operation unit 203 in the second embodiment, and is similar to the scan setting UI screen (FIG. 6A) in the first embodiment. FIG. 9B shows an example of a background color removal level setting UI screen to which the screen transitions from the scan setting UI screen after the button 604 has been pressed. The only difference between the background color removal level setting UI screen of FIG. 9B and the background color removal level setting UI screen in the first embodiment (FIG. 6C) is that a correction trace disappearance prevention button 901 has been provided. When the correction trace disappearance prevention button 901 is pressed, the setting, which satisfies the correction trace retaining condition in the electronic bookkeeping act, is performed. It should be noted that a detailed flowchart in the case where the correction trace disappearance prevention button 901 has been pressed will be described in <Restricting of UI operation in correction trace disappearance prevention setting> that will be described below.

FIG. 9C shows an example of the background color removal level setting UI screen changed due to pressing of the correction trace disappearance prevention button 901 of FIG. 9B. In order to retain correction traces, the gauge 611, the mark 612, the “+” button 613, and the “−” button 614 that are related to the background color removal level are grayed out, and UI operations thereof are not capable of being performed (the gauge 611, the mark 612, the “+” button 613, and the “−” button 614 become in a UI-inoperable state). As a result, the setting change of the background color removal level is disabled. Furthermore, in order to prevent the background color removal processing from being executed, the mark 612 is moved to the leftmost position and the value of the background color removal level is set to 0. It should be noted that by pressing the correction trace disappearance prevention button 901 again, the user is able to cancel the UI-inoperable state caused by graying out.

FIG. 9D shows an example of the scan setting UI screen to which the screen transitions from the background color removal level setting UI screen after the OK button 615 of FIG. 9C has been pressed. On the scan setting UI screen of FIG. 9D, “correction trace disappearance prevention”, which is characters based on pressing of the correction trace disappearance prevention button 901, is displayed in the background color removal level display part 616. Furthermore, on the scan setting UI screen of FIG. 9D, “dark reading” is displayed in the reading mode display part 610.

FIG. 9E shows an example of a reading mode setting UI screen to which the screen transitions from the scan setting UI screen after the button 603 of FIG. 9D has been pressed. The only difference between the reading mode setting UI screen of FIG. 9E and the reading mode setting UI screen in the first embodiment (FIG. 6B) is that a correction trace disappearance prevention button 902 has been provided. In the second embodiment, in conjunction with the change in the background color removal level setting UI screen of FIG. 9B, the buttons 608 and 609 on the reading mode setting UI screen of FIG. 9E are also grayed out, and UI operations thereof are not capable of being performed (the buttons 608 and 609 become in the UI-inoperable state). As a result, the setting change of the reading mode is disabled. Furthermore, in order for dark reading to be executed, the value of the reading mode flag is set to 1. In addition, on the reading mode setting UI screen of FIG. 9E, similar to the background color removal level setting UI screen of FIG. 9C, by pressing the correction trace disappearance prevention button 902, the user is able to cancel the UI-inoperable state caused by graying out.

Therefore, when the correction trace disappearance prevention button 901 or the correction trace disappearance prevention button 902 is pressed twice, the UI-inoperable state caused by graying out of the reading mode setting UI screen and the UI-inoperable state caused by graying out of the background color removal level setting UI screen are cancelled. It should be noted that on the reading mode setting UI screen where the UI-inoperable state caused by graying out has been cancelled, even in the case where the correction trace disappearance prevention button 902 has been pressed, the state described above will occur. In other words, the buttons 608 and 609 are grayed out and become in the UI-inoperable state, and the value of the reading mode flag is set to 1. In addition, on the background color removal level setting UI screen, in conjunction with the change in the reading mode setting UI screen, the gauge 611, the mark 612, the “+” button 613, and the “−” button 614 are grayed out and become in the UI-inoperable state, and the value of the background color removal level is set to 0. Furthermore, on the scan setting UI screen, “correction trace disappearance prevention” is displayed in the background color removal level display part 616. It should be noted that in the second embodiment, even in the case where the setting change of the reading mode and the background color removal level has been disabled, the user is able to select one of “text/photograph/map”, “printed photograph”, “text”, and “electronic document save mode” as the document type. This is different from the first embodiment. The above is the description of the scan setting and the UI operations in the second embodiment.

### <Restricting of UI Operation in Correction Trace Disappearance Prevention Setting>

FIG. 10 is a flowchart that shows the flow from when the correction trace disappearance prevention button 901 or the correction trace disappearance prevention button 902 is pressed to when restricting of the UI operation is performed. Respective steps (the control method for the image processing apparatus) of the flowchart shown in FIG. 10 are realized in the MFP 101 by the CPU 205 (the computer) reading a program, which has been stored in the storage unit 210, into the RAM 206 and executing the program. In the flowchart shown in FIG. 10, first, in a step S1001, the CPU 205 (the first determining unit) determines whether or not pressing (the first predetermined operation) of the correction trace disappearance prevention button 901 or the correction trace disappearance prevention button 902 (the first predetermined button) has been performed (the determining step).

In the case where the CPU 205 determines that pressing of the correction trace disappearance prevention button 901 or the correction trace disappearance prevention button 902 has been performed, the processing proceeds to a step S1002. On the other hand, in the case where the CPU 205 determines that both pressing of the correction trace disappearance prevention button 901 and pressing of the correction trace disappearance prevention button 902 have not been performed, the flowchart shown in FIG. 10 ends. Steps S1002 and S1003 are similar to the steps S702 and S703 that have been described above, respectively, and therefore their description will be omitted. In a step S1004, the CPU 205 (the change-disabling unit) restricts the UI operation on the reading mode setting UI screen and the background color removal level setting UI screen, thereby disabling the setting change of the reading mode and the background color removal level (the change-disabling step).

Specifically, the CPU 205 grays out the buttons 608 and 609 (first setting buttons) on the reading mode setting UI screen (FIG. 9E) displayed on the operation unit 203. As a result, the CPU 205 performs operation restriction by disabling input via the buttons 608 and 609. It should be noted that in the case where the CPU 205 (the second determining unit) determines that pressing (the second predetermined operation) of the correction trace disappearance prevention button 902 (the second predetermined button) on the reading mode setting UI screen (FIG. 9E) has been performed, the CPU 205 (the cancelling unit) cancels the operation restriction to be performed in the step S1004. As a result, the user is able to cancel the operation restriction to be performed in the step S1004 simply by performing an operation of pressing the correction trace disappearance prevention button 902.

In addition, the CPU 205 grays out the gauge 611, the mark 612, the “+” button 613, and the “−” button 614 (second setting buttons) on the background color removal level setting UI screen (FIG. 9C) displayed on the operation unit 203. As a result, the CPU 205 performs operation restriction by disabling input via the gauge 611, the mark 612, the “+” button 613, and the “−” button 614. It should be noted that in the case where the CPU 205 (the second determining unit) determines that pressing (the second predetermined operation) of the correction trace disappearance prevention button 901 (the second predetermined button) on the background color removal level setting UI screen (FIG. 9C) has been performed, the CPU 205 (the cancelling unit) cancels the operation restriction to be performed in the step S1004. As a result, the user is able to cancel the operation restriction to be performed in the step S1004 simply by performing an operation of pressing the correction trace disappearance prevention button 901.

In a step S1005, the CPU 205 (a notification display unit) displays “correction trace disappearance prevention” (a notification) in the background color removal level display part 616 on the scan setting UI screen (FIG. 9D) displayed on the operation unit 203. As a result, “correction trace disappearance prevention” is displayed near the button 604 corresponding to the background color removal level. In this way, when “correction trace disappearance prevention” is displayed, when the user is about to touch the button 604 to perform the setting change of the background color removal level, the user is able to know that the operation restriction has been performed by looking at “correction trace disappearance prevention” displayed near the button 604. Thereafter, the flowchart shown in FIG. 10 ends.

In addition, although not shown, the CPU 205 (the notification display unit) may display “correction trace disappearance prevention” instead of “dark reading” in the reading mode display part 610 on the scan setting UI screen (FIG. 9D) displayed on the operation unit 203. As a result, “correction trace disappearance prevention” is displayed near the button 603 corresponding to the reading mode. In this way, when “correction trace disappearance prevention” is displayed, when the user is about to touch the button 603 to perform the setting change of the reading mode, the user is able to know that the operation restriction has been performed by looking at “correction trace disappearance prevention” displayed near the button 603. It should be noted that in this case, “correction trace disappearance prevention” may be displayed on both the background color removal level display part 616 and the reading mode display part 610, or may be displayed only on the reading mode display part 610.

The above is the description of restricting of the UI operation in the case where the correction trace disappearance prevention button 901 or the correction trace disappearance prevention button 902 has been pressed. In this way, the MFP 101 is able to prevent unexpected setting changes by graying out the buttons 608, 609, 613, 614, etc., which allow changes to be made to the settings related to the correction trace retaining condition in the electronic bookkeeping act.

As described above, in the second embodiment, in the case where the correction trace disappearance prevention button 901 or the correction trace disappearance prevention button 902 has been pressed, dark reading is executed and the background color removal processing is not executed, while restricting of the UI operation is performed by means of disabling input by graying out. As a result, when generating an electronic document from a document, the MFP 101 is able to suppress the disappearance of the correction trace due to the reading mode and/or the background color removal processing. In addition, unlike the first embodiment, even in the case where a type other than the electronic document save mode has been selected as the document type, the MFP 101 is able to suppress the disappearance of the correction trace when generating an electronic document from a document. In addition, the user is able to cause the MFP 101 to generate, from a document, an electronic document in which the disappearance of the correction trace has been suppressed simply by performing an operation of pressing either the correction trace disappearance prevention button 901 or the correction trace disappearance prevention button 902.

Although the preferred embodiments of the present disclosure have been described above, the present disclosure is not limited to the above-described embodiments, and various modifications and changes are possible within the scope of the gist of the present disclosure. For example, the method of restricting the UI operation is not limited to graying out. However, it is desirable that a UI screen in the case where restricting of the UI operation is performed in a method different from graying out is a UI screen, which realizes that “the user is able to recognize that the UI operation is being restricted” and that “the user is able to cancel restricting of the UI operation”.

In addition, in general situations where dark reading is performed, the value of the background color removal level is often set to 0. Therefore, in the case where the button 609 (the first predetermined button) corresponding to the dark reading mode is pressed (the first predetermined operation) and the value of the reading mode flag has been set to 1, the CPU 205 may set the value of the background color removal level to 0 in conjunction with this and further restrict the UI operation. Alternatively, in the case where the “−” button 614 (the first predetermined button) is pressed (the first predetermined operation) and the value of the background color removal level has been set to 0, the CPU 205 may set the value of the reading mode flag to 1 in conjunction with this and further restrict the UI operation. In these cases, the user is able to cause the MFP 101 to generate, from a document, an electronic document in which the disappearance of the correction trace has been suppressed simply by performing an operation of pressing the button 609 corresponding to the dark reading mode or the “−” button 614.

In addition, in the step S703 in the first embodiment or in the step S1003 in the second embodiment, the CPU 205 may set the threshold value of the background color removal level to a value less than 255 if the conditions of the electronic bookkeeping act are satisfied. In this case, the value that has been set as the threshold value of the background color removal level corresponds to the second threshold value, and a value less than the value that has been set as the threshold value of the background color removal level corresponds to the first threshold value. In addition, in the second embodiment, only one of the correction trace disappearance prevention button 901 and the correction trace disappearance prevention button 902 may be provided. In addition, the buttons related to the present disclosure are not limited to the buttons on the UI screen, and may be buttons with physical mechanism, except for those requiring a display function such as graying out. In addition, the present disclosure can be realized in a single-function scanner device, etc., in addition to the MFP.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-031261, filed on Mar. 1, 2024, which is hereby incorporated by reference herein in its entirety.

What is claimed is:

1. An image processing apparatus that comprises
a reading unit configured to read a document and obtain read image data;
an adjusting unit configured to convert a color of each of pixels having a brightness equal to or greater than a threshold value in the read image data into white; and
an operation unit configured to be capable of performing at least a user operation regarding the reading unit and a user operation regarding the adjusting unit,
the image processing apparatus comprising:
at least one processor; and
a memory coupled to the processor storing instructions that, when executed by the processor, cause the processor to function as:
a first determining unit that determines whether or not a first predetermined operation has been performed by the operation unit;
a reading mode setting unit that, in a case where the first determining unit determines that the first predetermined operation has been performed by the operation unit, sets a reading mode of the reading unit to a second reading mode in which the document is read under a darker condition than a first reading mode;
a threshold value setting unit that, in the case where the first determining unit determines that the first predetermined operation has been performed by the operation unit, sets the threshold value of the adjusting unit to a second threshold value that is greater than a first threshold value; and
a change-disabling unit that disables a change of the second reading mode that has been set by the reading mode setting unit and a change of the second threshold value that has been set by the threshold value setting unit.

2. The image processing apparatus according to claim 1, wherein
the second threshold value is a value of a brightness indicating white.

3. The image processing apparatus according to claim 1, wherein
the first predetermined operation is an operation performed by a user on a first predetermined button provided in the operation unit.

4. The image processing apparatus according to claim 3, wherein
the first predetermined button is a button that the user operates to set an electronic document as a type of the document.

5. The image processing apparatus according to claim 3, wherein
the first predetermined button is a button that the user operates to cause the image processing apparatus to execute the reading mode setting unit, the threshold value setting unit, and the change-disabling unit.

6. The image processing apparatus according to claim 3, wherein
the first predetermined button is a button that the user operates to set the second reading mode as the reading mode of the reading unit.

7. The image processing apparatus according to claim 3, wherein
the first predetermined button is a button that the user operates to set the second threshold value as the threshold value of the adjusting unit.

8. The image processing apparatus according to claim 1, wherein
the change-disabling unit performs operation restriction, which disables an operation that a user performs setting of the reading mode of the reading unit and an operation that the user performs setting of the threshold value of the adjusting unit, in the operation unit.

9. The image processing apparatus according to claim 8, wherein
the processor is caused to further function as a UI screen display unit that displays a UI screen on the operation unit, and
the change-disabling unit performs the operation restriction by graying out a first start button that the user operates to start the setting of the reading mode of the reading unit and a second start button that the user operates to start the setting of the threshold value of the adjusting unit on the UI screen of the operation unit.

10. The image processing apparatus according to claim 8, wherein
the processor is caused to further function as a UI screen display unit that displays a UI screen on the operation unit, and
the change-disabling unit performs the operation restriction by graying out a first setting button that the user operates to set the reading mode of the reading unit and a second setting button that the user operates to set the threshold value of the adjusting unit on the UI screen of the operation unit.

11. The image processing apparatus according to claim 8, wherein
the processor is caused to further function as
a UI screen display unit that displays a UI screen on the operation unit; and
a notification display unit that displays, on the UI screen of the operation unit, a notification indicating that the operation restriction is being performed.

12. The image processing apparatus according to claim 11, wherein
the change-disabling unit performs the operation restriction by graying out a first setting button that the user operates to set the reading mode of the reading unit and a second setting button that the user operates to set the threshold value of the adjusting unit on the UI screen of the operation unit, and
the notification display unit displays, on the UI screen of the operation unit, the notification indicating that the operation restriction is being performed near a first start button that the user operates to start the setting of the reading mode of the reading unit or near a second start button that the user operates to start the setting of the threshold value of the adjusting unit.

13. The image processing apparatus according to claim 8, wherein
the processor is caused to further function as
a second determining unit that determines whether or not a second predetermined operation has been performed by the operation unit; and
a cancelling unit that, in a case where the second determining unit determines that the second predetermined operation has been performed by the operation unit, cancels the operation restriction.

14. The image processing apparatus according to claim 13, wherein
the second predetermined operation is an operation performed by the user on a second predetermined button provided in the operation unit.

15. The image processing apparatus according to claim 14, wherein
the second predetermined button is a button among a plurality of buttons for setting a type of the document, which is operated by the user to set a type other than an electronic document as the type of the document.

16. The image processing apparatus according to claim 14, wherein
the second predetermined button is a button that the user operates to cause the image processing apparatus to execute the reading mode setting unit, the threshold value setting unit, and the change-disabling unit.

17. The image processing apparatus according to claim 1, wherein
the darker condition is at least one of a less irradiation light amount, a lower light receiving sensitivity, and a shorter light receiving time than the first reading mode.

18. A control method for an image processing apparatus that comprises
a reading unit configured to read a document and obtain read image data;
an adjusting unit configured to convert a color of each of pixels having a brightness equal to or greater than a threshold value in the read image data into white; and
an operation unit configured to be capable of performing at least a user operation regarding the reading unit and a user operation regarding the adjusting unit,
the control method comprising:
a determining step of determining whether or not a predetermined operation has been performed by the operation unit;
a reading mode setting step of, in a case of being determined in the determining step that the predetermined operation has been performed by the operation unit, setting a reading mode of the reading unit to a second reading mode in which the document is read under a darker condition than a first reading mode;
a threshold value setting step of, in the case of being determined in the determining step that the predetermined operation has been performed by the operation unit, setting the threshold value of the adjusting unit to a second threshold value that is greater than a first threshold value; and
a change-disabling step of disabling a change of the second reading mode that has been set in the reading mode setting step and a change of the second threshold value that has been set in the threshold value setting step.

19. A non-transitory computer-readable storage medium storing a program for causing a computer to execute a control method for an image processing apparatus that comprises
a reading unit configured to read a document and obtain read image data;
an adjusting unit configured to convert a color of each of pixels having a brightness equal to or greater than a threshold value in the read image data into white; and
an operation unit configured to be capable of performing at least a user operation regarding the reading unit and a user operation regarding the adjusting unit,
the control method comprising:
a determining step of determining whether or not a predetermined operation has been performed by the operation unit;
a reading mode setting step of, in a case of being determined in the determining step that the predetermined operation has been performed by the operation unit, setting a reading mode of the reading unit to a second reading mode in which the document is read under a darker condition than a first reading mode;
a threshold value setting step of, in the case of being determined in the determining step that the predetermined operation has been performed by the operation unit, setting the threshold value of the adjusting unit to a second threshold value that is greater than a first threshold value; and
a change-disabling step of disabling a change of the second reading mode that has been set in the reading mode setting step and a change of the second threshold value that has been set in the threshold value setting step.
